(19) United States
(12) Patent Application Publication
(10) Pub. No.: US 2008/0036780 A1
(43) Pub. Date: Feb. 14, 2008

(54) Turbo station for computing systems

(76) Inventors: Jeffrey Liang, Menlo Park, CA (US); Greg Kaine, Sunnyvale, CA (US); Eric Debes, Santa Clara, CA (US)

Correspondence Address: CAVEN & AGHEVLI;c/o INTELLEVATE, P.O. BOX 52050, MINNEAPOLIS, MN, 55402, US

(21) Appl. No.: 11/891,646

(22) Filed: Aug. 10, 2007

Related U.S. Application Data
(63) Continuation-in-part of application No. 11/502,170, filed on Aug. 10, 2006.

(51) Int. Cl. G06T 1/00

(52) U.S. Cl. 345/522

(57) ABSTRACT

In one embodiment, a system comprises a portable computing device comprising a first graphics controller and a first communication interface, and a turbo station comprising a second communication interface to manage communication with the portable computing device, and at least one auxiliary computing component comprising a multi-core graphics engine coupled to the communication interface and configured to process cooperatively with the first graphics controller in the portable computing device.

### RELATED APPLICATIONS

This application is a continuation-in-part of U.S. patent application Ser. No. 11/502,170, entitled TURBO STATION FOR COMPUTING SYSTEMS, to Liang, et al., the disclosure of which is incorporated herein in its entirety.

### BACKGROUND

The subject matter described herein relates generally to the field of electronic communication and more particularly to a turbo station for computing systems.

At present, portable computing systems such as, e.g. laptop computers, commonly fall into one of two product categories: “thin and light” systems and desktop replacement systems. Physical form factors, e.g., size and weight, play an important role in the design of thin and light laptop computing systems. Because many components and systems that increase the performance of computing systems consume space and add weight, designers of thin and light laptop systems are sometimes forced to compromise performance factors to accommodate physical form factors. By contrast, desktop replacement systems commonly sacrifice physical form factors, e.g., size and weight, to accommodate the components and systems that increase the performance of computing systems.

### BRIEF DESCRIPTION OF THE DRAWINGS

The detailed description is described with reference to the accompanying figures.

FIG. 1 is a schematic illustration of a computing system adapted to accommodate a turbo station in accordance with some embodiments.

FIG. 2 is a schematic illustration of a computing system 200 adapted to accommodate a turbo station, according to some embodiments.

FIG. 3 is a flowchart illustrating operations performed to activate a turbo station in accordance with some embodiments.

FIG. 4 is a flowchart illustrating operations performed to deactivate a turbo station in accordance with some embodiments.

FIG. 5 is a schematic illustration of a computing system including a turbo station in accordance with some embodiments.

FIG. 6 is a schematic illustration of a computing system adapted to accommodate a turbo station, according to some embodiments.

FIG. 7 is a flowchart illustrating operations performed to activate a turbo station in accordance with some embodiments.

FIG. 8 is a flowchart illustrating operations performed to deactivate a turbo station in accordance with some embodiments.

### DETAILED DESCRIPTION

Described herein are exemplary systems and methods for implementing a turbo station in computing systems. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

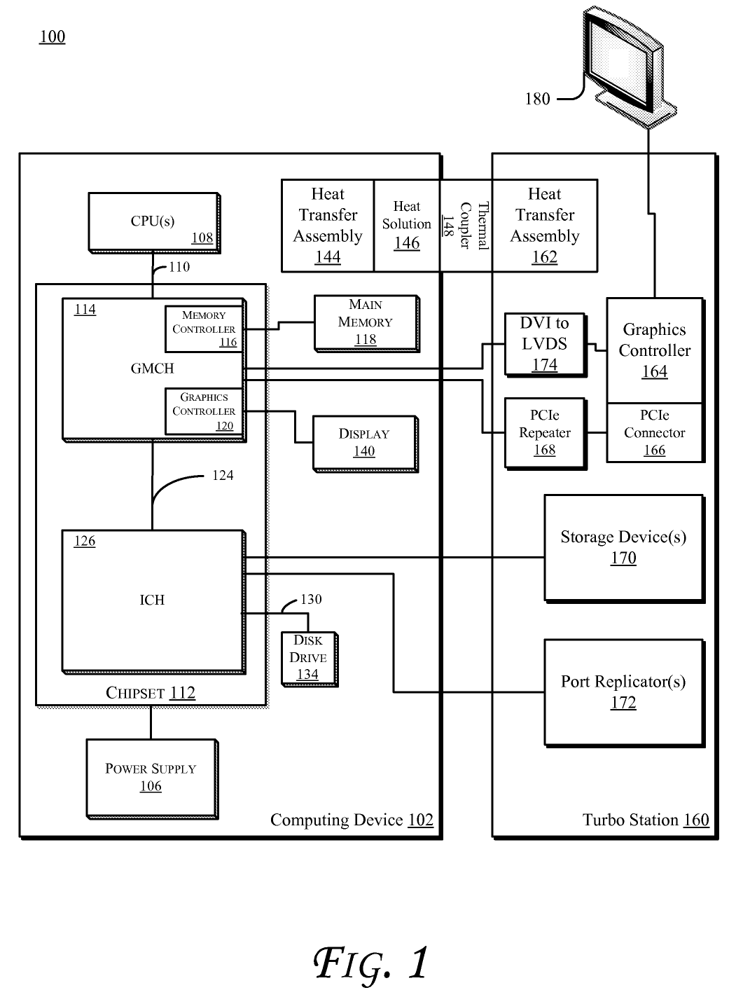

FIG. 1 is a schematic illustration of a system 100 adapted to accommodate a turbo station in accordance with some embodiments. The system 100 includes a computing device 102. The computing device 102 may be any suitable computing device such as a portable (i.e., laptop or notebook) computer, a personal digital assistant, a desktop computing device (e.g., a workstation or a desktop computer), a rack-mounted computing device, and the like.

Electrical power may be provided to various components of the computing device 102 (e.g., through a computing device power supply 106) from one or more of the following sources: one or more battery packs, an alternating current (AC) outlet (e.g., through a transformer and/or adaptor such as a power adapter), automotive power supplies, airplane power supplies, and the like. In one embodiment, a power adapter may transform the power supply source output (e.g., the AC outlet voltage of about 110 VAC to 240 VAC) to a direct current (DC) voltage ranging between about 7 VDC to 12.6 VDC.

The computing device 102 may also include one or more central processing unit(s) (CPUs) 108 coupled to a bus or interconnect technology 110. In one embodiment, the CPU 108 may be one or more processors in the Pentium® family of processors including the Pentium® II processor family, Pentium® III processors, Pentium® IV processors, Pentium® M processors available from Intel® Corporation of Santa Clara, Calif. Alternatively, other CPUs may be used, such as Intel's Itanium®®, XEON™, and Celeron® processors. Also, one or more processors from other manufactures may be utilized. Moreover, the processors may have a single or multi core design.

A chipset 112 may be coupled to the bus 110 or interconnect technology 110. The chipset 112 may include a graphics and memory control hub (GMCH) 114. The GMCH 114 may include a memory controller 116 that is coupled to a main system memory 118. The main system memory 118 stores data and sequences of instructions that are executed by the CPU 108, or any other device included in the system 100. In one embodiment, the main system memory 118 includes random access memory (RAM); however, the main system memory 118 may be implemented using other memory types such as dynamic RAM (DRAM), synchronous DRAM (SDRAM), and the like. Additional devices may also be coupled to the bus 110, such as multiple CPUs and/or multiple system memories.

The GMCH 114 (also called a Northbridge) may also include a graphics controller 120 coupled to a display (such as e.g., a flat panel display) 140. In some embodiments, graphics controller 120 may be implemented as an integrated graphics controller. The display 140 signals produced by the display device may pass through various control devices before being interpreted by and subsequently displayed on the display.

A hub interface 124 couples the MCH 114 (also called a Northbridge) to an input/output control hub (ICH) 126. The ICH 126 (also called a Southbridge) provides an interface to input/output (I/O) devices coupled to the computer system 100. The ICH 126 may be coupled to one or more busses such as, e.g., a Universal Serial Bus (USB), a peripheral component interconnect (PCI) bus, an Advanced Technology Attachment (ATA) or Serial ATA (SATA) bus. Additionally, other types of I/O interconnect topologies may be utilized such as the PCI Express™ (PCIe) architecture, available through Intel® Corporation of Santa Clara, Calif.

In some embodiments one or more disk drives(s) 134 may be coupled to a PCI bus 130. In other embodiments one or more disk drive(s) 134 may be coupled to ICH 126 via a serial ATA (SATA) or an IDE, or other suitable interface. Other devices may be coupled to the PCI bus 130. In addition, the CPU 108 and the GMCH 114 may be combined to form a single chip.

Additionally, other peripherals coupled to the ICH 126 may include, in various embodiments, Serial ATA (SATA) or integrated drive electronics (IDE) or small computer system interface (SCSI) hard drive(s) and optical disc drive(s), universal serial bus (USB) port(s), a keyboard, a mouse, parallel port(s), serial port(s), floppy disk drive(s), digital output support (e.g., digital video interface (DVI)), and the like. Hence, the computing device 102 may include volatile and/or nonvolatile memory.

Computing device 102 may further include a heat transfer assembly 144 and a heat solution 146 such as, e.g., a heatsink with fan assembly. In some embodiments, the heat transfer assembly 144 may include a heat pipe that circulates a fluid throughout portions of computing device 102 to remove heat from heat-generating components such as, e.g., CPUs 108 and chipset 112. Heated fluid such as, e.g., water, is brought into thermal contact with heat solution 146, which exchanges heat from the fluid with the ambient external air.

System 100 further includes a turbo station 160. In some embodiments, turbo station 160 may be implemented as a docking station with thermal, physical, and electrical interconnects adapted to couple with computing device 102. Turbo station 160 includes one or more ports to connect one or more discrete graphics controllers 164. In some embodiments, graphics controller 164 may be implemented as a PCIe graphics card. A PCIe connector 166 may be coupled to graphics controller 164 and may be coupled to GMCH 114 via a PCIe connection. Graphics controller 164 may be coupled to a display 180 or its DVI lanes converted into low voltage differential signaling (LVDS) by DVI to LVDS converter 174 and rerouted to the laptop panel.

In some embodiments, the 16 PCIe lanes may be routed from the GMCH through a docking connector, into the base station, and to a desktop PCIe connector 166. To simplify routing and reduce power consumption, the PCIe link can be reduced, e.g., to an 8-lane or a four lane connection.

In the event that the total trace length from the GMCH 114 to the graphics controller inside the turbo station leads to unacceptable signal degradation, turbo station 160 may include a PCIe repeater 168 to regenerate PCIe signals on the links. In some embodiments, a PCIe switch may double as a PCIe repeater 168, in addition to enabling a multiple graphics controller configuration, such as Scalable Link Interface (SLI) or Crossfire. In some embodiments, a PCIe switch also provides the flexibility to couple devices other than graphics devices to computing device 102.

Turbo station 160 may also include one or more storage devices 170. In some embodiments, storage devices 170 may be implemented as magnetic disk drives such as, e.g., serial ATA (SATA) disk drives, optical drives, magnetic tape drives, or other storage devices. Storage devices 170 may be coupled to ICH 126 via a communication link such as, e.g., a PCIe link.

Turbo station 160 may also include one or more port replicators 172. For example, the port replicators 172 may include an audio port, a universal serial bus (USB) port, a Video Graphics Array (VGA) port, a Digital Visual Interface (DVI) port, an Ethernet port, a Personal System/2 (PS2) port, a parallel port, a communication port, or the like.

Turbo station 160 may further include a heat transfer assembly 162. In some embodiments, heat transfer assembly 162 may include a Thermo-Electric Cooler (TEC) coupled with a heatsink and fan assembly. In some embodiments, TEC may include a plurality of P-type and N-type semiconductor blocks, in many cases Bismuth Telluride, packaged between thin ceramic plates. A TEC uses the Peltier effect to transfer heat between the plates. When current is applied, a TEC functions as a heat pump, pushing heat from one side of the heatsink to the other. In some embodiments, a fan assembly circulates air from the cold side throughout turbo station 160.

In some embodiments, a thermal coupler 148 provides thermal connection between heat solution 146 such as, e.g., a heat pump or other heat transfer device and heat transfer assembly 162. For example, thermal coupler 148 may be implemented as a thermally conductive plate positioned in thermal communication with heat solution 146 and with heat transfer assembly 162. Thus, heat transfer assembly can function as an auxiliary heat transfer system to remove heat from computing device 102 when computing device 102 is coupled with turbo station 160.

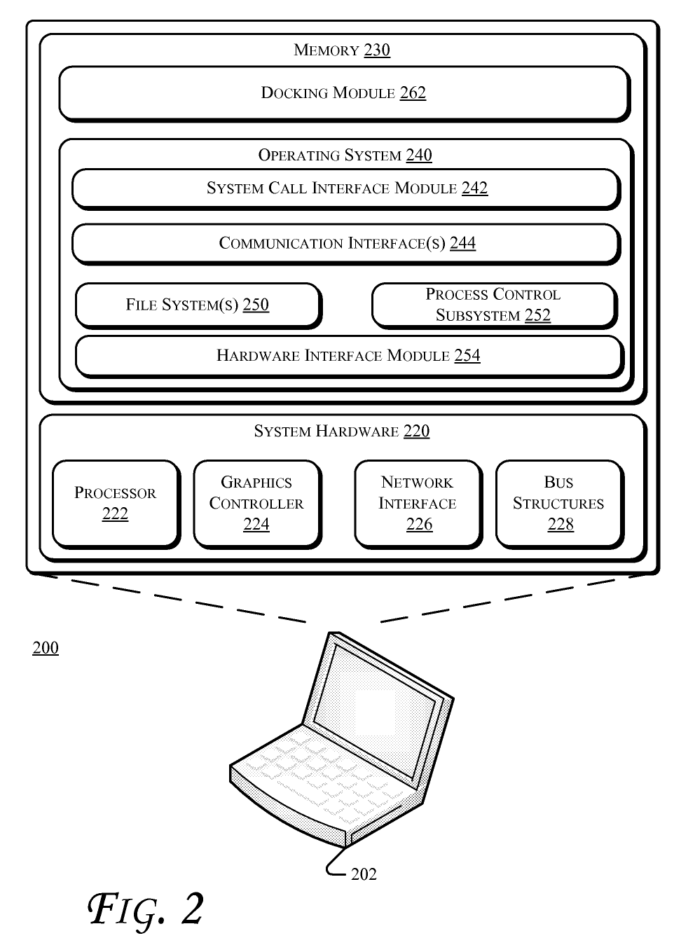

FIG. 2 is a schematic illustration of a computing system 200 adapted to accommodate a turbo station, according to some embodiments. Computing system 200 may correspond to the computing device 102 depicted in FIG. 1. Computing system 200 includes a computing device 202 and one or more accompanying input/output devices including a display, one or more speakers, a keyboard, and one or more other I/O device(s). In some embodiments, the computing device 202 may be embodied as a personal computer, a laptop computer, a personal digital assistant, a mobile telephone, an entertainment device, or another computing device.

The computing device 202 includes system hardware 220 and memory 230, which may be implemented as random access memory and/or read-only memory. System hardware 220 may include one or more processors 222, video controllers 224, network interfaces 226, and bus structures 228. In some embodiments, processor 222 may be embodied as an Intel® Pentium IV® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics controller 224 may function as an adjunction processor that manages graphics and/or video operations. Graphics controller 224 may be integrated onto the motherboard of computing system 200 or may be coupled via an expansion slot on the motherboard.

In some embodiments, network interface 226 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 228 connect various components of system hardware 228. In some embodiments, bus structures 228 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 230 may include an operating system 240 for managing operations of computing device 208. In some embodiments, operating system 240 includes a hardware interface module 254 that provides an interface to system hardware 220. In addition, operating system 240 may include a file system 250 that manages files used in the operation of computing device 208 and a process control subsystem 252 that manages processes executing on computing device 208.

Operating system 240 may include (or manage) one or more communication interfaces that may operate in conjunction with system hardware 220 to transceive data packets and/or data streams from a remote source. Operating system 240 may further include a system call interface module 242 that provides an interface between the operating system 240 and one or more application modules resident in memory 230. Operating system 240 may be embodied as a UNIX operating system or any derivative thereof (e.g., Linux, Solaris, etc.) or as a Windows® brand operating system, or other operating systems.

In some embodiments, memory 230 includes a docking module 262 to manage cooperation between computing system 200 when the computing system 200 is coupled to a turbo station such as, e.g., the turbo station 160 depicted in FIG. 1. In some embodiments, docking module 262 may be implemented as an application that executes on computing system 200. In alternate embodiments, docking module 262 may be implemented as a component of the operating system or the basic input-output system (BIOS) of computing system 200.

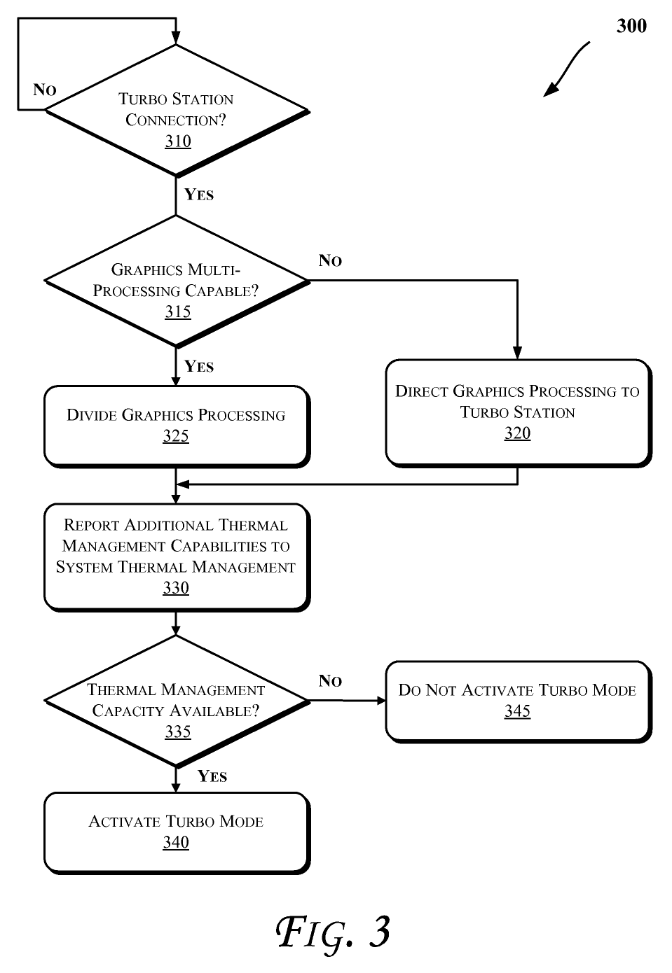

FIG. 3 is a flowchart illustrating operations performed by docking module 262 to activate a turbo station in accordance with some embodiments. Referring to FIGS. 1-3, at operation 310 the docking module 262 monitors for a signal indicating that the computing device 102 is coupled to a turbo station 160. In some embodiments, the operating system may generate an interrupt such as, e.g., a hot-plug or system interrupt signal when the computing device 102 is coupled to turbo station 160. In some embodiments the computing device 102 may not accommodate a hot-plug capability, and the system 102 may need to be reset to enable a connection between the computing system 102 and the turbo station 160.

If, at operation 315, computing device 102 is not capable of balancing graphics loads across multiple controllers, then control passes to operation 320 and graphics processing functions may be directed to the graphics controller 164 on turbo station 160. By contrast, if at operation 315, computing device 102 is capable of graphics multiprocessing, then control passes to operation 325 and graphics processing functions may be divided between the graphics controller 120 on computing device 102 and the graphics controller 164 on turbo station 160.

At operation 330 the thermal management capacity of the heat transfer system components 144, 146, 148, 162 are reported. If, at operation 335 thermal management capacity is unavailable, then control passes to operation 345 and a turbo processing mode is bypassed. By contrast, if at operation 335 thermal management capacity is available, then control passes to operation 340 and a turbo processing mode is activated. For example, the performance of one or more components may be increased, either through increases in frequency or by enabling additional platform components or chip functionality. For instance, CPUs could enable additional cores in turbo mode, additional memory could be powered on, or Graphics Processing Units (GPU) could enable additional pipelines. The heat solution 146 working cooperatively with the heat transfer assembly 162 in the turbo station 160 increases the heat transfer capacity of the heat transfer assembly 144, thereby allowing the computing device 102 to operate at higher speeds.

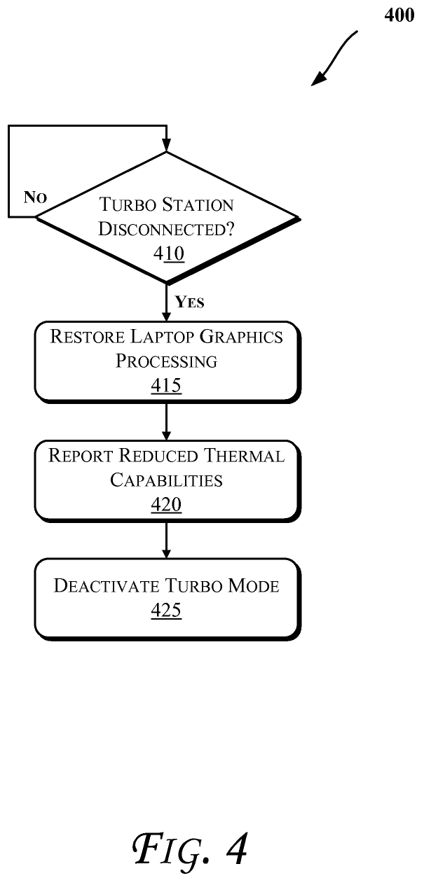

FIG. 4 is a flowchart illustrating operations performed by docking module 262 to deactivate a turbo station in accordance with some embodiments. Referring to FIGS. 1-4, at operation 410 the docking module 262 monitors for a signal indicating that the computing device 102 has been disconnected from turbo station 160. In some embodiments, the operating system may generate an interrupt such as, e.g., a plug and play (PNP) interrupt signal when the computing device 102 disconnects from turbo station 160.

In response to the disconnection signal, graphics processing is restored to the graphics controller 120 on computing device 102 at operation 415. At operation 420 the reduced thermal capabilities are reported, and at operation 425 the turbo mode is deactivated at operation 420. Thus, computing device 102 returns to functioning as a stand-alone computing device. In response to the reduction in thermal capability, the system will dynamically adjust component performance states.

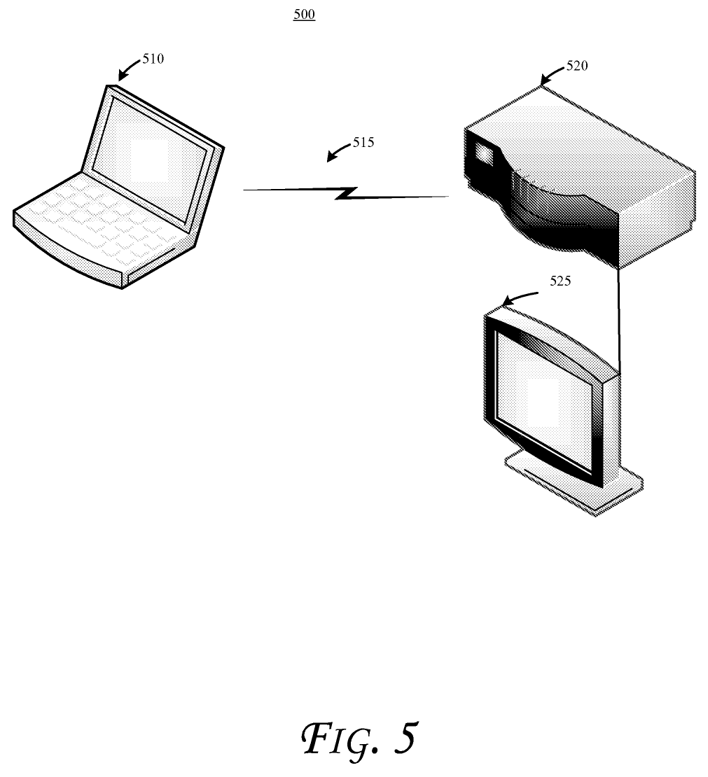

In some embodiments, a turbo station may be implemented as a device that comprises a multi-core processing system such as, for example, a media appliance that comprises a multi-core graphics processing system. FIG. 5 is a schematic illustration of a computing system including a turbo station in accordance with some embodiments. Referring to FIG. 5, in some embodiments a system 500 may comprise a portable computing device such as, for example, a laptop computer 510. Laptop computer 510 may be communicatively coupled to a media appliance 520 via a communication link 515. Communication link 515 may be implemented as a wireless communication connection or a hardwired communication connection. Media appliance 520 may be implemented as a personal video recorder, content server, a digital video recorder, or the like. Media appliance 520 may be coupled to one or more displays 525.

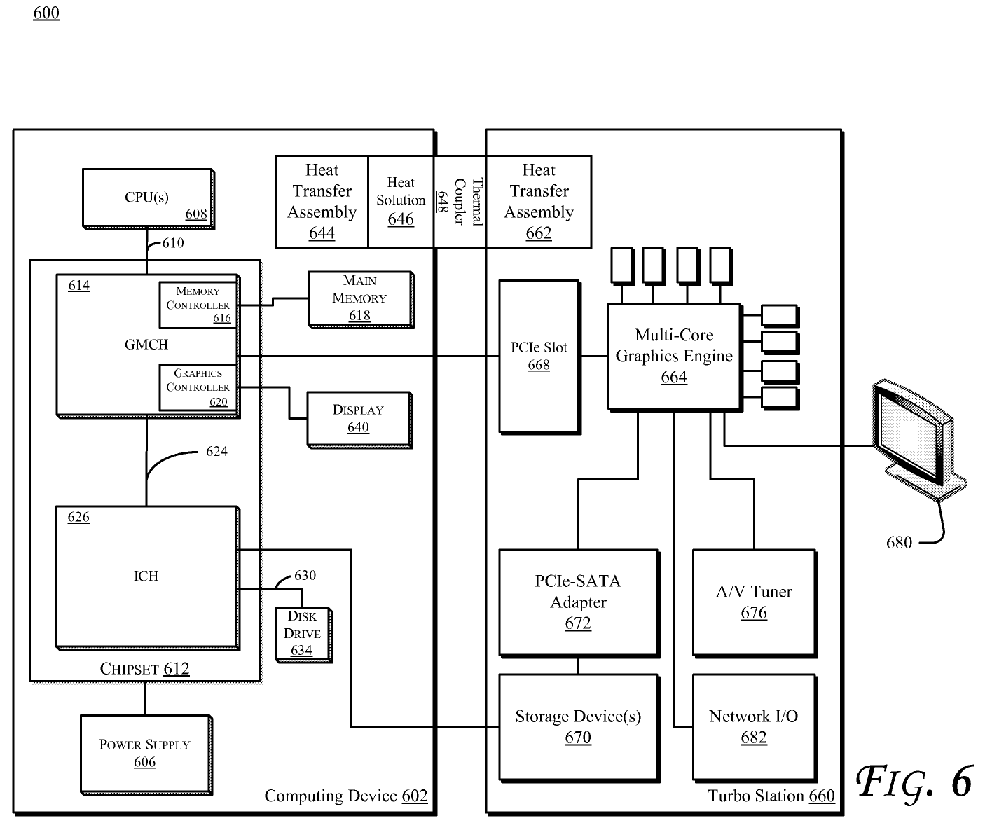

FIG. 6 is a schematic illustration of a system 600 adapted to accommodate a turbo station in accordance with some embodiments. The system 600 includes a computing device 602. The computing device 602 may be any suitable computing device such as a portable (i.e., laptop or notebook) computer, a personal digital assistant, a desktop computing device (e.g., a workstation or a desktop computer), a rack-mounted computing device, and the like.

Electrical power may be provided to various components of the computing device 602 (e.g., through a computing device power supply 606) from one or more of the following sources: one or more battery packs, an alternating current (AC) outlet (e.g., through a transformer and/or adaptor such as a power adapter), automotive power supplies, airplane power supplies, and the like. In one embodiment, a power adapter may transform the power supply source output (e.g., the AC outlet voltage of about 110 VAC to 240 VAC) to a direct current (DC) voltage ranging between about 7 VDC to 12.6 VDC.

The computing device 602 may also include one or more central processing unit(s) (CPUs) 608 coupled to a bus or interconnect technology 610. In one embodiment, the CPU 608 may be one or more processors in the Pentium® family of processors including the Pentium® II processor family, Pentium® III processors, Pentium® IV processors, Pentium® M processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 612 may be coupled to the bus 610 or interconnect technology 610. The chipset 612 may include a graphics and memory control hub (GMCH) 614. The GMCH 614 may include a memory controller 616 that is coupled to a main system memory 618. The main system memory 618 stores data and sequences of instructions that are executed by the CPU 608, or any other device included in the system 600. In one embodiment, the main system memory 618 includes random access memory (RAM); however, the main system memory 618 may be implemented using other memory types such as dynamic RAM (DRAM), synchronous DRAM (SDRAM), and the like. Additional devices may also be coupled to the bus 610, such as multiple CPUs and/or multiple system memories.

The GMCH 614 may also include a graphics controller 620 coupled to a display (such as e.g., a flat panel display) 640. In some embodiments, graphics controller 620 may be implemented as an integrated graphics controller. The display 640 signals produced by the display device may pass through various control devices before being interpreted by and subsequently displayed on the display.

A hub interface 624 couples the MCH 614 to an input/output control hub (ICH) 626. The ICH 626 provides an interface to input/output (I/O) devices coupled to the computer system 600. The ICH 626 may be coupled to one or more busses such as, e.g., a Universal Serial Bus (USB), a peripheral component interconnect (PCI) bus, an Advanced Technology Attachment (ATA) or Serial ATA (SATA) bus. Additionally, other types of I/O interconnect topologies may be utilized such as the PCI Express™ (PCIe) architecture, available through Intel® Corporation of Santa Clara, Calif.

In some embodiments one or more disk drives(s) 634 may be coupled to a PCI bus 630. In other embodiments one or more disk drive(s) 634 may be coupled to ICH 626 via a serial ATA (SATA) or an IDE, or other suitable interface. Other devices may be coupled to the PCI bus 630. In addition, the CPU 608 and the GMCH 614 may be combined to form a single chip.

Additionally, other peripherals coupled to the ICH 626 may include, in various embodiments, Serial ATA (SATA) or integrated drive electronics (IDE) or small computer system interface (SCSI) hard drive(s) and optical disc drive(s), universal serial bus (USB) port(s), a keyboard, a mouse, parallel port(s), serial port(s), floppy disk drive(s), digital output support (e.g., digital video interface (DVI)), and the like. Hence, the computing device 602 may include volatile and/or nonvolatile memory.

Computing device 602 may further include a heat transfer assembly 644 and a heat solution 646 such as, e.g., a heatsink with fan assembly. In some embodiments, the heat transfer assembly 644 may include a heat pipe that circulates a fluid throughout portions of computing device 602 to remove heat from heat-generating components such as, e.g., CPUs 608 and chipset 612. Heated fluid such as, e.g., water, is brought into thermal contact with heat solution 646, which exchanges heat from the fluid with the ambient external air.

System 600 further includes a turbo station 660. In some embodiments, turbo station 660 may be implemented as a media appliance with thermal, physical, and electrical interconnects adapted to couple with computing device 602. In addition, turbo station 660 may include one or more wireless networking input/output cards (i.e., Network I/O 682) to enable a wireless communication connection with computing device 602.

Turbo station 660 includes one or more multi-core graphics engines 164. In some embodiments, graphics engine 664 may be implemented as a PCIe graphics card. A PCIe connector 666 may be coupled to graphics engine 664 and may be coupled to GMCH 114 via a PCIe connection. Graphics engine 664 may be coupled to a display 680 or its DVI lanes converted into low voltage differential signaling (LVDS) by a DVI to LVDS converter and rerouted to the computing device 602, in like manner as described above.

In some embodiments, the 16 PCIe lanes may be routed from the GMCH through a docking connector, into the base station, and to a desktop PCIe slot 668. To simplify routing and reduce power consumption, the PCIe link can be reduced, e.g., to an 8-lane or a four lane connection.

Turbo station 160 may also include one or more storage devices 670 coupled to the graphics engine 664 via a PCIe-SATA (Serial ATA) adapter 672. In some embodiments, storage devices 670 may be implemented as magnetic disk drives such as, e.g., serial ATA (SATA) disk drives, optical drives, magnetic tape drives, or other storage devices. Storage devices 670 may be coupled to ICH 626 via a communication link such as, e.g., a PCIe link. Turbo station 660 may further comprise an audio/visual (A/V) tuner 676.

Turbo station 660 may further include a heat transfer assembly 662. In some embodiments, heat transfer assembly 662 may include a Thermo-Electric Cooler (TEC) coupled with a heatsink and fan assembly. In some embodiments, TEC may include a plurality of P-type and N-type semiconductor blocks, in many cases Bismuth Telluride, packaged between thin ceramic plates. A TEC uses the Peltier effect to transfer heat between the plates. When current is applied, a TEC functions as a heat pump, pushing heat from one side of the heatsink to the other. In some embodiments, a fan assembly circulates air from the cold side throughout turbo station 660.

In some embodiments, a thermal coupler 648 provides thermal communication between heat solution 646 such as, e.g., a heat pump or other heat transfer device and heat transfer assembly 662. For example, thermal coupler 648 may be implemented as a thermally conductive plate positioned in thermal communication with heat solution 646 and with heat transfer assembly 662. Thus, heat transfer assembly can function as an auxiliary heat transfer system to remove heat from computing device 602 when computing device 602 is coupled with turbo station 660.

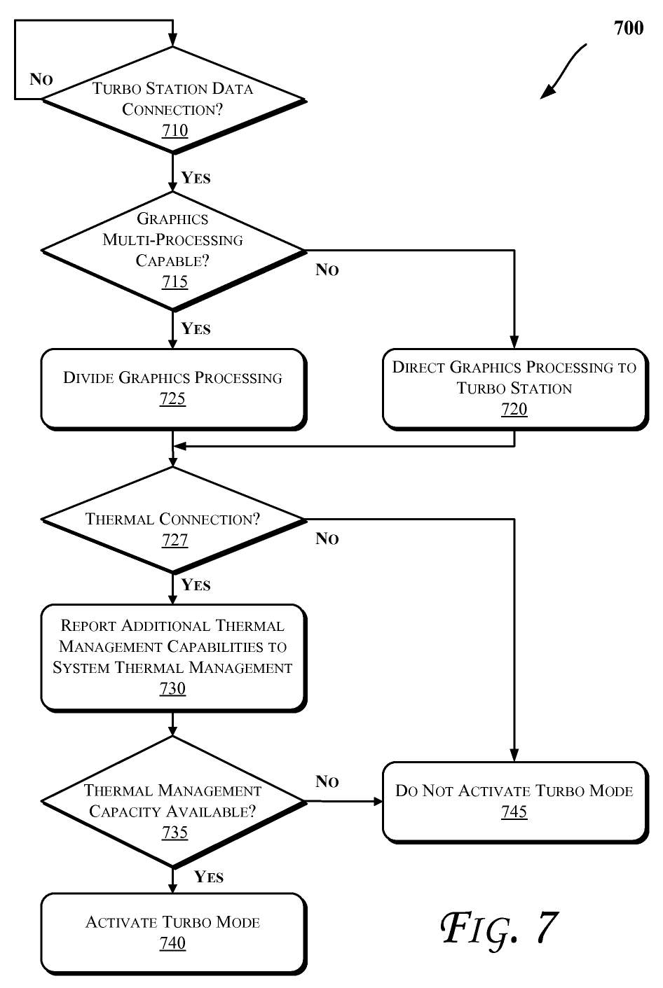

FIG. 7 is a flowchart illustrating operations performed to activate a turbo station in accordance with some embodiments. Referring to FIGS. 5-7, at operation 710 the docking module 662 monitors for a signal indicating that the computing device 602 is coupled to a turbo station 660. The signal may indicate that the device In some embodiments, the computing device 602 is physically coupled with turbo station 660, or that a data connection has been established between the computing device 602 in the turbo station 660. For example, in embodiments in which the computing device 602 and a turbo station 660 include wireless communication capabilities the signal may indicate that a wireless data connection has been established between the computing device 602 in the turbo station 660. In some embodiments, the operating system may generate an interrupt such as, e.g., a hot-plug or system interrupt signal when the computing device 602 is coupled to turbo station 660. In some embodiments the computing device 602 may not accommodate a hot-plug capability, and the system 602 may need to be reset to enable a connection between the computing system 602 and the turbo station 660.

If, at operation 715, computing device 602 is not capable of graphics multiprocessing, then control passes to operation 720 and graphics processing functions may be directed to the graphics engine 664 on turbo station 660. By contrast, if at operation 715, computing device 602 is capable of graphics multiprocessing, then control passes to operation 725 and graphics processing functions may be divided between the graphics controller 620 on computing device 602 and the graphics engine 664 on turbo station 660.

If, at operation 727, there is no thermal connection between the computing device 602 and turbo station 660 (i.e., if the heat transfer assembly 662 is coupled to the heat solution 646 by thermal coupler 648, then control passes to operation 745 and the turbo mode is not activated. By contrast, if at operation 727 there is a thermal connection between the computing device 602 and the turbo station 660, then control passes to operation 730.

At operation 730 the thermal management capacity of the heat transfer system components 644, 646, 648, 662 are reported. If, at operation 735 thermal management capacity is unavailable, then control passes to operation 745 and a turbo processing mode is bypassed. By contrast, if at operation 735 thermal management capacity is available, then control passes to operation 740 and a turbo processing mode is activated. For example, the performance of one or more components may be increased, either through increases in frequency or by enabling additional platform components or chip functionality. For instance, CPUs could enable additional cores in turbo mode, additional memory could be powered on, or Graphics Processing Units (GPU) could enable additional pipelines. The heat solution 646 working cooperatively with the heat transfer assembly 662 in the turbo station 660 increases the heat transfer capacity of the heat transfer assembly 644, thereby allowing the computing device 602 to operate at higher speeds.

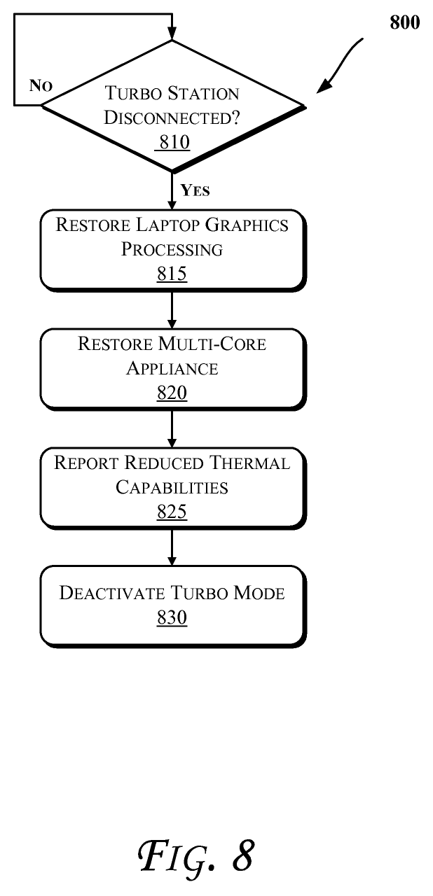

FIG. 8 is a flowchart illustrating operations performed by docking module 662 to deactivate a turbo station in accordance with some embodiments. Referring to FIGS. 5-8, at operation 810 the docking module 662 monitors for a signal indicating that the computing device 602 has been disconnected from turbo station 660. In some embodiments, the operating system may generate an interrupt such as, e.g., a plug and play (PNP) interrupt signal when the computing device 602 disconnects from turbo station 660.

In response to the disconnection signal, graphics processing is restored to the graphics controller 620 on computing device 602 at operation 815. At operation 820 the multi-core appliance is restored. At operation 825 the reduced thermal capabilities are reported, and at operation 843 the turbo mode is deactivated. Thus, computing device 602 returns to functioning as a stand-alone computing device. In response to the reduction in thermal capability, the system will dynamically adjust component performance states.

Some of the operations described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” “some embodiments” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
a communication interface to manage communication with an external computing device; and
at least one auxiliary computing component comprising a multi-core graphics engine coupled to the communication interface and configured to process cooperatively with one or more computing components in the external computing device.

2. The apparatus of claim 1, wherein the communication interface comprises at least one of:
a PCI express bus;
a PCIe switch; or
a PCIe repeater module.

3. The apparatus of claim 1, wherein:
the external computing device comprises a first heat transfer system; and
the apparatus further comprises an auxiliary heat transfer system configured to cooperate with the first heat transfer system.

4. The apparatus of claim 3, wherein:
the auxiliary heat transfer system comprises a heat dissipation device that couples with the first heat transfer system to dissipate heat from the external computing device.

5. The apparatus of claim 1, wherein:
the external computing system comprises a portable computer;
the laptop computer comprises a first graphics controller; and
the at least one auxiliary computing component comprises a second graphics controller.

6. The apparatus of claim 5, wherein the second graphics controller cooperates with the first graphics controller.

7. The apparatus of claim 5, wherein the second graphics controller supplants operation of the first graphics controller.

8. A system, comprising:
a portable computing device comprising a first graphics controller and a first communication interface; and
a turbo station comprising:
a second communication interface to manage communication with the portable computing device; and
at least one auxiliary computing component comprising a multi-core graphics engine coupled to the communication interface and configured to process cooperatively with the first graphics controller in the portable computing device.

9. The system of claim 8, wherein:
the first graphic controller comprises an integrated graphics device; and
the at least one auxiliary computing component comprises a PCI express graphics device.

10. The system of claim 8, wherein the second communication interface comprises at least one of:
a PCI express bus;
a PCIe Switch; or
a PCI express repeater module.

11. The system of claim 8, wherein:
the portable computing device comprises a first heat transfer system; and
the turbo station further comprises an auxiliary heat transfer system configured to cooperate with the first heat transfer system.

12. The system of claim 11, wherein:
the auxiliary heat transfer system comprises a heat dissipation device that couples with the first heat transfer system to dissipate heat from external computing device.

13. The system of claim 8, wherein:
the portable computing system comprises a laptop computer;
the laptop computer comprises a first graphics controller; and
the at least one auxiliary computing component comprises a second graphics controller.

14. The system of claim 13, wherein the second graphics controller cooperates with the first graphics controller.

15. The system of claim 13, wherein the second graphics controller supplants operation of the first graphics controller.

16. A method, comprising:
detecting, in a first processor, a data connection to a second processor, wherein the second processor comprises a multi-core graphics engine; and
transferring responsibility for a portion of processing performed by the first controller to the second controller.

17. The method of claim 16, wherein detecting, in a first controller, a connection to a second controller comprises detecting an interrupt signal.

18. The method of claim 16, wherein transferring responsibility for a portion of processing performed by the first controller to the second controller comprises determining whether a device is capable of graphics multi-processing.

19. The method of claim 16, further comprising activating a turbo mode when adequate thermal management capacity is available.

20. The method of claim 16, further comprising:
detecting, in the first controller, a disconnection from the second controller; and, in response thereto:
restoring responsibility for processing to the first controller;
determining a thermal management capacity; and
deactivating a turbo mode.
